(19) United States
(12) Patent Application Publication
(10) Pub. No.: US 2010/0055479 A1
(43) Pub. Date: Mar. 4, 2010

(54) Coating for a combustion chamber defining component

(75) Inventors: M. Brad Beardsley, Laura, IL (US); Mark D. Veliz, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/230,529

(22) Filed: Aug. 29, 2008

(51) Int. Cl. B32B 15/00; B05D 1/36; B05D 3/12; C23C 4/08; C23C 4/12; C23C 4/10

(52) U.S. Cl. 428/457; 427/404; 427/419.7; 427/367; 427/456; 427/450; 428/411.1

(57) ABSTRACT

A method for coating a combustion chamber defining component is disclosed. The method includes applying a thermally conductive layer to a surface of the combustion chamber defining component, the thermally conductive layer having a thermal conductivity greater than the combustion chamber defining component.

### TECHNICAL FIELD

The present disclosure is directed to a combustion chamber defining component and, more particularly, to a coating for a combustion chamber defining component.

### BACKGROUND

During engine combustion, high temperatures within the combustion chamber may develop. These temperatures may reach, for example, between about 300 and about 800 degrees Celsius. Combustion chamber defining components such as, for example, a flame deck of an engine cylinder head facing the combustion chamber, may be subjected to high thermal stresses from combustion. The high thermal stresses may lead to failures in the cylinder head due to thermal fatigue. Portions of the cylinder head particularly prone to thermal fatigue may be areas where hot spots develop such as, for example, a valve port bridge between an exhaust valve opening and an air intake valve opening. Hot spots may develop in these areas because the valve openings reduce the amount of cylinder head sectional area available to conduct and dissipate the heat from combustion.

One attempt at protecting combustion chamber defining components from thermal stresses is described in U.S. Pat. No. 4,495,907 (the '907 patent) issued to Kamo. The '907 patent discloses a layer of thermally insulative material bonded to a combustion chamber defining component via a bonding material and impregnated with a soluble chromium compound. A barrier layer comprised of silica, chromium, and aluminum may be applied to the thermally insulative material.

Although the applied layers of the '907 patent may provide a method for protecting a combustion chamber defining component, it may fail to adequately dissipate heat away from hot spots of the component. Also, thermally insulative layers may have limited durability at high temperatures and may therefore fail to protect combustion chamber defining components.

The present disclosure is directed to overcoming one or more of the shortcomings set forth above and/or other deficiencies in the art.

### SUMMARY OF THE DISCLOSURE

In accordance with one aspect, the present disclosure is directed toward a method for coating a combustion chamber defining component. The method includes applying a thermally conductive layer to a surface of the combustion chamber defining component, the thermally conductive layer having a thermal conductivity greater than the combustion chamber defining component.

According to another aspect, the present disclosure is directed toward a method for coating a combustion chamber defining component. The method includes removing material from a substrate of the combustion chamber defining component and applying a thermally conductive layer to the substrate of the combustion chamber defining component, the thermally conductive layer having a thermal conductivity of between about 75 and about 450 Watt/meter*Kelvin. The method also includes applying an anti-oxidant layer to the thermally conductive layer.

### BRIEF DESCRIPTION OF THE DRAWINGS

FIG. 1 is a diagrammatic illustration of a portion of an exemplary disclosed engine;

FIG. 2 is a diagrammatic illustration of an exemplary disclosed cylinder head, viewed along line 2-2 of the engine portion of FIG. 1;

FIG. 3 is a cross-sectional illustration of the cylinder head, viewed along line 3-3 of FIG. 2; and

FIG. 4 is a flow chart of an exemplary disclosed coating method.

### DETAILED DESCRIPTION

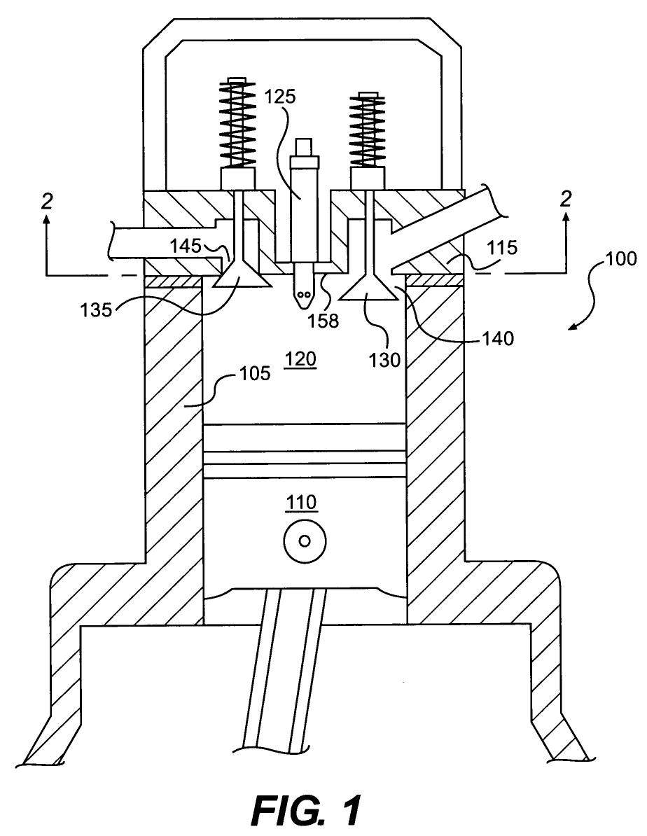

FIG. 1 illustrates a portion of an exemplary engine 100 that may be a four-stroke diesel or gasoline engine, or a gaseous fuel-powered engine. Engine 100 may include combustion chamber defining components such as, for example, at least one cylinder 105, piston 110, and cylinder head 115, which may together form at least one combustion chamber 120. Engine 100 may also include a fuel injector 125 and at least one intake valve 130 for selectively allowing fuel and air, respectively, into combustion chamber 120 to affect combustion. Engine 100 may additionally include an exhaust valve 135 for selectively releasing combustion gases from combustion chamber 120. Cylinder head 115 may include openings for receiving fuel injector 125, intake valve 130, exhaust valve 135, and other components of engine 100 such as, for example, fasteners for attaching cylinder head 115 to engine 100. Cylinder head 115 may be made from any suitable material such as, for example, cast iron or steel. Cylinder head 115 may be made from any suitable cast iron material such as, for example, grey cast iron or compacted graphite cast iron, and may have any suitable thermal conductivity (expressed in units of Watt per meter*Kelvin) such as, for example, between about 30 and about 60 Watt/meter*Kelvin, or between about 40 and about 50 Watt/meter*Kelvin. Cylinder head 115 may include coolant passages for receiving coolant to transfer heat away from cylinder head 115.

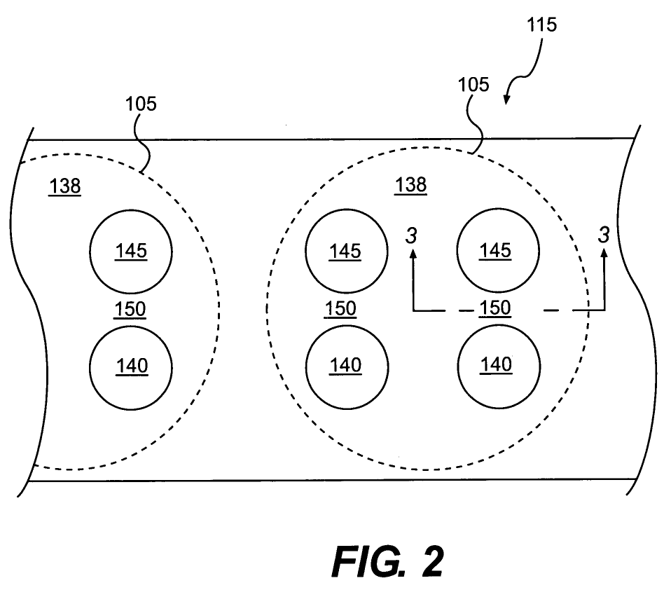

As illustrated in FIG. 2, cylinder head 115 may include a surface 138 that may be a flame deck that faces combustion chamber 120. Cylinder head 115 may also include at least one intake opening 140 for receiving intake valve 130, and at least one exhaust opening 145 for receiving exhaust valve 135. Cylinder head 115 may include additional openings for receiving other components of engine 100. Cylinder head 115 may include at least one valve port bridge 150 that may be disposed between intake opening 140 and exhaust opening 145.

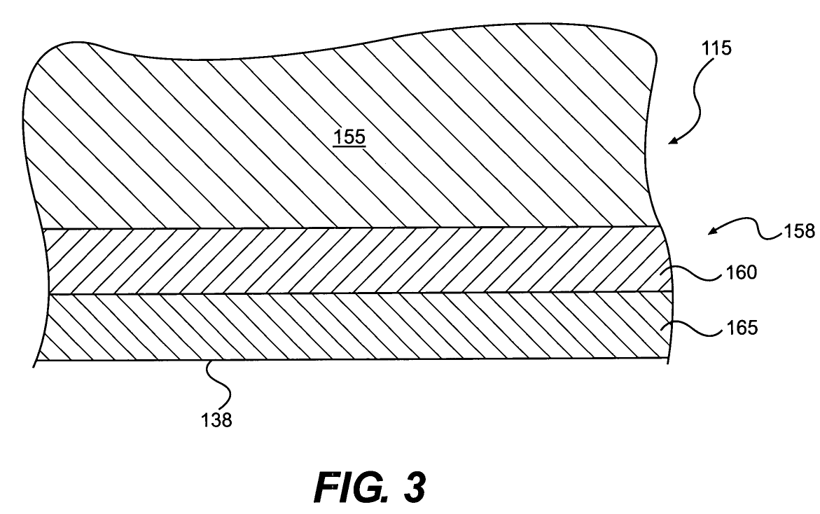

As illustrated in FIG. 3, cylinder head 115 may include a substrate 155, and a coating 158 to protect substrate 155. Coating 158 may include a first layer 160 provided on at least a portion of substrate 155, and a second layer 165 provided on at least a portion of first layer 160. Substrate 155 may be the material, such as cast iron or steel, making up cylinder head 115.

First layer 160 may be a thermally conductive layer provided on at least a portion of substrate 155 and may have a thermal conductivity such as, for example, of between about 75 and about 450 Watt/meter*Kelvin, between about 150 and about 400 Watt/meter*Kelvin, or between about 200 and about 300 Watt/meter*Kelvin. First layer 160 may be applied at areas of cylinder head 115 prone to hot spots such as, for example, valve port bridge 150 of flame deck surface 138, and other portions of flame deck surface 138. First layer 160 may be made from highly thermally conductive materials such as, for example, copper, aluminum, boron nitride, or silicon carbide. When made from a copper material, first layer 160 may have a thermal conductivity such as, for example, of between about 125 and about 395 Watt/meter*Kelvin, between about 150 and about 350 Watt/meter*Kelvin, or between about 200 and about 300 Watt/meter*Kelvin. First layer 160, when made from a copper material, may have a greater thermal conductivity than substrate 155. When made from a copper material, first layer 160 may transfer heat from combustion temperatures of up to at least about 800° Celsius. When made from an aluminum material, first layer 160 may have a high thermal conductivity such as, for example, of between about 70 and about 223 Watt/meter*Kelvin, between about 100 and about 200 Watt/meter*Kelvin, or between about 125 and about 175 Watt/meter*Kelvin. First layer 160, when made from aluminum material, may have a greater thermal conductivity than substrate 155. When made from an aluminum material, first layer 160 may transfer heat from combustion temperatures of up to at least about 600° Celsius. When made from a boron nitride material, first layer 160 may have a high thermal conductivity such as, for example, of between about 15 and about 33 Watt/meter*Kelvin, or between about 20 and about 30 Watt/meter*Kelvin. When made from a silicon carbide material, first layer 160 may have a high thermal conductivity such as, for example, of between about 75 and about 120 Watt/meter*Kelvin, or between about 85 and about 110 Watt/meter*Kelvin. First layer 160 may have any suitable thickness such as, for example, between about 0.1 μm and about 3.0 mm.

Second layer 165 may be provided on at least a portion of first layer 160 as a protective sealing layer to reduce oxidation of first layer 160 to a negligible amount under ambient conditions and under combustion conditions. Second layer 165 may be made from an anti-oxidant material and may provide a barrier between oxidizing effects of combustion within combustion chamber 120 and first layer 160. Second layer 165 may be a made from a nickel-chromium-aluminum-yttrium (NiCrAlY) material. The NiCrAlY material may include between about 54% and about 83% nickel, between about 15% and about 30% chromium, between about 2% and about 14% aluminum, and about 2% or less Yttrium. It is contemplated that second layer 165 may also be a NiCrAl material that may not include Yttrium. Second layer 165 may also be made from stainless steel. When made from NiCrALY, NiCrAl, or stainless steel material, second layer 165 may have any suitable thickness such as, for example, between about 0.1 μm and about 3.0 mm. Second layer 165 may alternatively be made from a zirconia ceramic material and may have a low thermal conductivity such as, for example, of between about 0.5 and about 2.2 Watt/meter*Kelvin, or between about 1.0 and about 2.0 Watt/meter*Kelvin. When made from the zirconia material, second layer 165 may have any suitable thickness such as, for example, between about 0.1 μm and about 1.0 mm. It is also contemplated that first layer 160 may include NiCrALY, NiCrAl, stainless steel, and/or zirconia material to reduce oxidation.

Prior to conducting heat from combustion into substrate 155, first layer 160 may conduct the heat from restricted locations on cylinder head 115 having a reduced sectional area and thereby being prone to developing hot spots such as, for example, an interior location between openings 140 and/or 145. First layer 160 may conduct the heat from the restricted locations to unrestricted locations of cylinder head 115 having a greater sectional area that is unreduced by openings such as, for example, openings 140 and/or 145. For example, first layer 160 may conduct heat radially outward from valve port bridges 150 toward an outside edge of cylinder head 115. Heat transfer by first layer 160 may reduce the probability of hot spots developing on cylinder head 115. When second layer 165 is made from zirconia material, the zirconia material may act as an insulating layer to retain heat in cylinder head 115 and thereby additionally improving an efficiency of engine 100.

### INDUSTRIAL APPLICABILITY

The disclosed coating may be used in any machine subject to thermal stresses such as, for example, a machine having an internal combustion engine. The disclosed coating may be used to coat any component prone to developing hot spots such as, for example, a combustion chamber defining component such as a cylinder head.

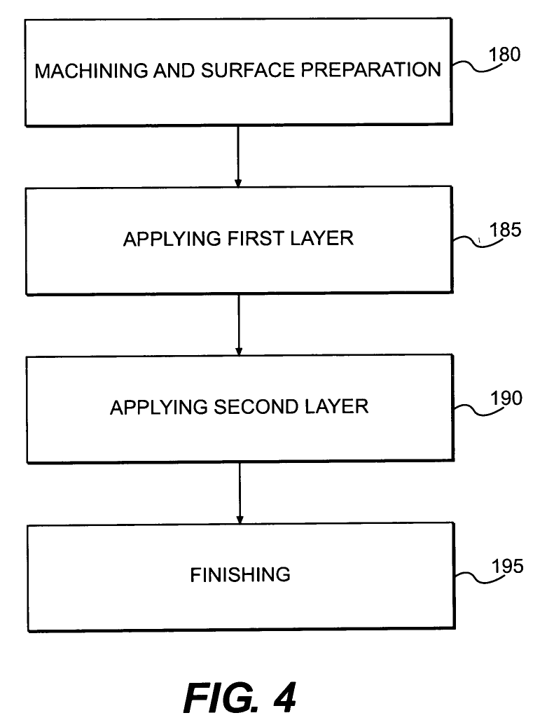

FIG. 4 provides a method for applying coating 158. Cylinder head 115 may be machined to remove a thickness of material from substrate 155 generally matching a combined thickness of first layer 160 and second layer 165 in step 180. Portions of cylinder head 115 not being coated may be masked, and the machined surface of substrate 155 may be grit-blasted to provide a prepared surface for the application of first layer 160. Step 180 may be suitable for remanufacturing an existing cylinder head 115 to receive coating 158.

In step 185, first layer 160 may be applied to substrate 155 via any suitable method known in the art such as, for example, high velocity oxy-fuel (HVOF) thermal spraying using powder or wire arc thermal spraying. First layer 160 may also be applied via a cold spraying technique or a plating technique. In step 190, second layer 165 may be applied to first layer 160 using a similar technique as step 185. In step 195, coating 158 may be finished by milling or grinding surface 138 to meet surface finish requirements of cylinder head 115.

Prior to conducting heat from combustion into substrate 155, first layer 160 may transfer the heat away from locations on cylinder head 115 prone to developing hot spots, thereby reducing thermal stresses in substrate 155 of cylinder head 115. Second layer 165 may substantially reduce oxidation of first layer 160 from combustion. Coating 158 may thereby reduce thermal stresses from combustion within combustion chamber 120.

It will be apparent to those skilled in the art that various modifications and variations can be made to the disclosed coating. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A method for coating a combustion chamber defining component, comprising:
applying a thermally conductive layer to a surface of the combustion chamber defining component, the thermally conductive layer having a thermal conductivity greater than the combustion chamber defining component.

2. The method of claim 1, wherein the thermally conductive layer is made from at least one of a copper, an aluminum, a boron nitride, or a silicon carbide material.

3. The method of claim 1, wherein the thermally conductive layer conducts heat from a location of the combustion chamber defining component having a reduced sectional area toward a location of the combustion chamber defining component having a greater sectional area.

4. The method of claim 1, wherein the thermally conductive layer conducts heat radially outward from a valve port bridge of the combustion chamber defining component.

5. The method of claim 1, further including applying a protective layer to the thermally conductive layer.

6. The method of claim 5, wherein the protective layer is made from at least one of a NiCrAlY, a NiCrAl, a stainless steel, or a zirconia material.

7. The method of claim 5, wherein the protective layer reduces oxidation of the thermally conductive layer to a negligible amount.

8. The method of claim 1, wherein the combustion chamber defining component is a cylinder head.

9. The method of claim 8, wherein the thermally conductive layer is applied to a flame deck of the cylinder head.

10. A method for coating a combustion chamber defining component, comprising:
removing material from a substrate of the combustion chamber defining component;
applying a thermally conductive layer to the substrate of the combustion chamber defining component, the thermally conductive layer having a thermal conductivity of between about 75 and about 450 Watt/meter*Kelvin; and
applying an anti-oxidant layer to the thermally conductive layer.

11. The method of claim 10, wherein the thermally conductive layer is made from at least one of a copper, an aluminum, a boron nitride, or a silicon carbide material.

12. The method of claim 11, wherein the copper thermally conductive layer has a thermal conductivity of between about 125 and about 395 Watt/meter*Kelvin.

13. The method of claim 11, wherein the aluminum thermally conductive layer has a thermal conductivity of between about 70 and about 223 Watt/meter*Kelvin.

14. The method of claim 10, wherein the anti-oxidant layer is made from at least one of a NiCrAlY, a NiCrAl, a stainless steel, or a zirconia material.

15. The method of claim 10, further including milling or grinding a surface of the coating.

16. The method of claim 10, wherein the thermally conductive layer and the anti-oxidant layer are applied via thermal spraying, plating, or cold spraying.

17. A combustion chamber defining component, comprising:
a substrate material;
a layer of thermally conductive material provided on at least a portion of the substrate material, the thermally conductive layer having a thermal conductivity greater than the substrate material; and
a layer of anti-oxidant material provided on at least a portion of the thermally conductive material.

18. The combustion chamber defining component of claim 17, wherein the combustion chamber defining component is a cylinder head.

19. The combustion chamber defining component of claim 17, wherein the layer of thermally conductive material is made from at least one of a copper, an aluminum, a boron nitride, or a silicon carbide material.

20. The combustion chamber defining component of claim 17, wherein the layer of anti-oxidant material is made from at least one of a NiCrAlY, a NiCrAl, a stainless steel, or a zirconia material.
